(19) United States
(12) Patent Application Publication
(10) Pub. No.: US 2026/0274622 A1
(43) Pub. Date: Sep. 17, 2026

(54) MAINTENANCE LIFTING PLATFORM

(71) Applicant: Ninebot (Shenzhen) Tech Co., Ltd., Shenzhen (CN)

(72) Inventors: Xiesi ZHOU, Shenzhen (CN); Yi LOU, Shenzhen (CN); Fan YANG, Shenzhen (CN)

(21) Appl. No.: 19/459,507

(22) Filed: Jan. 26, 2026

(30) Foreign Application Priority Data
Mar. 14, 2025 (CN) 202520470586.1

(51) Int. Cl. B66F 7/06; B62H 3/00

(52) U.S. Cl. CPC B66F 7/0666; B62H 3/00

(57) ABSTRACT

A maintenance lifting platform includes a lifting main body, a bottom seat and a maintenance frame. The lifting main body includes a height-adjustable workbench; the bottom seat is connected to the workbench and provided with a limiting groove for limiting a workpiece to be maintained; the maintenance frame is connected to the workbench and includes a clamp for clamping the workpiece to be maintained, and the clamp is arranged above the bottom seat.

### CROSS-REFERENCE TO RELATED APPLICATION

The present disclosure is based on and claims priority to Chinese Patent Application No. 2025204705861, filed on Mar. 14, 2025, the entire content of which is incorporated into the present invention by reference.

### FIELD

The present disclosure relates to the technical field of maintenance devices for two-wheeled vehicles, and in particular to a maintenance lifting platform.

### BACKGROUND

A maintenance platform for an electric bicycle in the related art mainly fall into two categories, one of which is a vertical maintenance stand equipped with a clamp, and adjustment of maintenance height of such tool sometimes requires manual assistance, which consumes the physical strength of maintenance personnel and cannot clamp an overly heavy vehicle due to its structural characteristics; and the other category is a traditional scissor-type lifting platform; although it solves the maintenance of some heavy-duty vehicles with chassis, it fails to secure an electric bicycle without chassis, and maintenance tools used in the maintenance process are difficult to access quickly, making it impossible to improve maintenance efficiency.

### SUMMARY

The present disclosure aims to solve at least one of the technical problems in the related art to a certain extent.

To this end, embodiments of the present disclosure provide a maintenance lifting platform, which has the advantages of adjustable height for the workpiece to be maintained and high fixing reliability of the workpiece to be maintained on the workbench.

The maintenance lifting platform according to the embodiments of the present disclosure includes a lifting main body including a height-adjustable workbench; a bottom seat connected to the workbench and having a limiting groove for limiting a workpiece to be maintained; and a maintenance frame connected to the workbench and including a clamp for clamping the workpiece to be maintained, wherein the clamp is arranged above the bottom seat.

According to the maintenance lifting platform of the present disclosure embodiments, by mounting the maintenance frame and the bottom seat on the workbench of the lifting main body, the heights of the maintenance frame and the bottom seat are adjustable, which in turn enables the height adjustment of the workpiece to be maintained clamped and fixed by the clamp of the maintenance frame, thus improving the maintenance convenience of the workpiece to be maintained. In addition, the bottom seat realizes the limiting of the workpiece to be maintained through the limiting groove, which ensures high fixing reliability of a heavy workpiece and/or a chassis-free workpiece to be maintained on the workbench and further enhances the safety of maintenance personnel during the maintenance operation.

### BRIEF DESCRIPTION OF THE DRAWINGS

FIG. 1 is a schematic diagram of a maintenance lifting platform according to an embodiment of the present disclosure.

FIG. 2 is a schematic diagram of a lifting main body and a ramp in a maintenance lifting platform according to an embodiment of the present disclosure.

FIG. 3 is another schematic diagram of a lifting main body and a ramp in a maintenance lifting platform according to an embodiment of the present disclosure, with a bellows cover omitted.

FIG. 4 is a schematic diagram of a bottom seat in a maintenance lifting platform according to an embodiment of the present disclosure.

FIG. 5 is a schematic diagram of a maintenance frame in a maintenance lifting platform according to an embodiment of the present disclosure.

FIG. 6 is an exploded view of a maintenance frame in a maintenance lifting platform according to an embodiment of the present disclosure.

### DETAILED DESCRIPTION

Embodiments of the present disclosure are described in detail below, and examples of the embodiments are shown in the accompanying drawings. Embodiments described below with reference to the accompanying drawings are illustrative and intended to explain the present disclosure, but should not be construed as limiting the present disclosure.

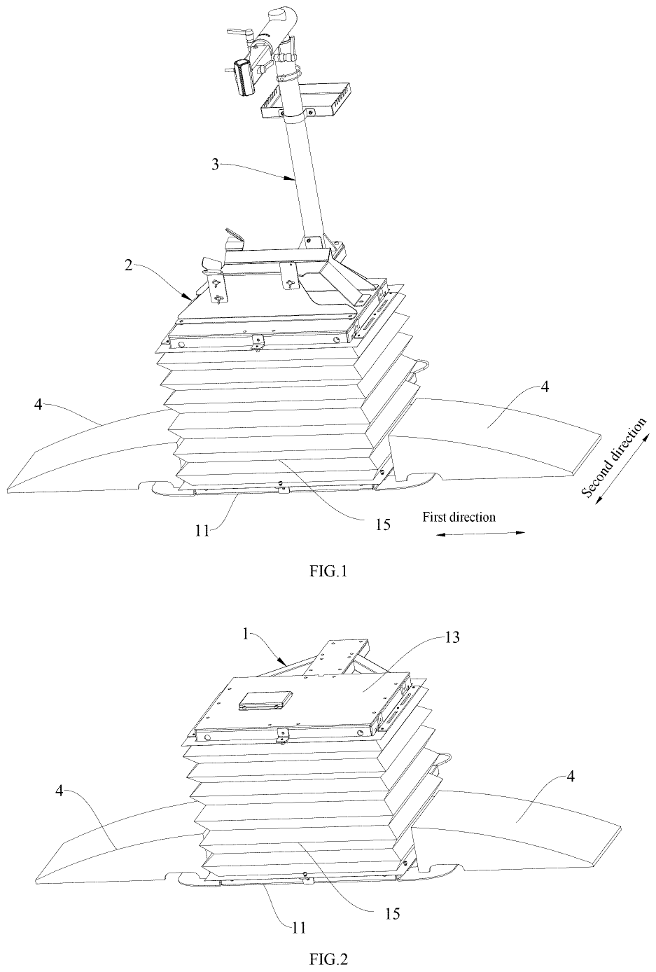

A maintenance lifting platform according to embodiments of the present disclosure is described below with reference to FIGS. 1-6.

The maintenance lifting platform according to embodiments of the present disclosure includes a lifting main body 1, a bottom seat 2 and a maintenance frame 3, and the lifting main body 1 includes a height-adjustable workbench 13. The bottom seat 2 is connected to the workbench 13 and is provided with a limiting groove for limiting a workpiece to be maintained. The maintenance frame 3 is connected to the workbench 13 and includes a clamp 33 for clamping the workpiece to be maintained, and the clamp 33 is arranged above the bottom seat 2.

According to the maintenance lifting platform of embodiments of the present disclosure, by mounting the maintenance frame 3 and the bottom seat 2 on the workbench 13 of the lifting main body 1, the heights of the maintenance frame 3 and the bottom seat 2 are adjustable, which in turn enables the height adjustment of the workpiece to be maintained which is clamped and fixed by the clamp 33 of the maintenance frame 3, thus improving the maintenance convenience of the workpiece to be maintained. In addition, the bottom seat 2 realizes the limiting of the workpiece to be maintained through the limiting groove, which ensures high fixing reliability of heavy and/or chassis-free workpieces to be maintained on the workbench 13 and further enhances the safety of maintenance personnel during the maintenance operation.

It should be noted that the workpiece to be maintained is a two-wheeled vehicle, which includes a chassis-free vehicle and a chassis-equipped vehicle. The bottom seat 2 is detachably mounted on the workbench 13, and the bottom seat 2 can be solely used to achieve reliable limiting of chassis-free vehicles; and the bottom seat 2 of the maintenance lifting platform can be removed to place the chassis-equipped vehicles directly on the workbench 13 when maintaining chassis-equipped vehicles.

In some embodiments, as shown in FIGS. 1, 2 and 3, the lifting main body 1 includes a base 11, a scissor support bracket 12, a driving device and a bellows cover 15. The scissor support bracket 12 is arranged between the base 11 and the workbench 13. The driving device is mounted on the base 11 and is drivingly connected to the scissor support bracket 12 to facilitate the lifting and lowering of the workbench 13. Two ends of the bellows cover 15 are respectively connected to the base 11 and the workbench 13, and the scissor support bracket 12 is located inside the bellows cover 15.

The bellows cover 15 isolates the scissor support bracket 12 from the external environment, effectively preventing external components from entering the scissor support bracket 12 and affecting its lifting reliability. The arrangement of the driving device enables automatic lifting and lowering of the scissor support bracket 12, further improving the maintenance convenience of the workpiece to be maintained.

In some embodiments, as shown in FIG. 3, the scissor support bracket 12 includes a first upper rod, a second upper rod, a first lower rod and a second lower rod. The first upper rod is pivotally connected to the second upper rod; the lower end of the first upper rod is pivotally connected to the upper end of the first lower rod; the lower end of the second upper rod is pivotally connected to the upper end of the second lower rod; the upper end of the first upper rod is fixedly connected to the workbench 13; the upper end of the second upper rod is slidably connected to the workbench 13 along a first direction via a bearing; the first lower rod is pivotally connected to the second lower rod; the lower end of the first lower rod is fixedly connected to the base 11; the lower end of the second lower rod is slidably connected to the base 11 along the first direction via a bearing. All the aforementioned pivot axes extend along a second direction.

In addition, two first upper rods, two first lower rods, two second upper rods and two second lower rods are arranged at intervals along the second direction respectively. A first support rod is connected between the lower ends of the two first upper rods, and a second support rod is connected between the lower ends of the two second upper rods. The driving device is an electric push rod 14, which is rotatably mounted on the base 11; a movable end of the electric push rod 14 is pivotally connected to the first support rod.

It should be noted that the electric push rod 14 automatically controls its movement stroke through a travel switch, to ensure that the lifting main body 1 has a set lifting stroke.

In some embodiments, the maintenance lifting platform further includes a ramp 4 connected to the base 11, and the ramp 4 and the base 11 are arranged along the first direction. The height of the upper surface of the ramp 4 gradually decreases in a direction away from the base 11, and the height of the upper surface of the workbench 13 at the lowest position is less than or equal to the maximum height of the upper surface of the ramp 4.

The arrangement of the ramp 4 allows the workpiece to be maintained to be pushed onto the workbench 13 via the ramp 4 and/or pushed off the workbench 13 via the ramp 4 when the upper surface of the workbench 13 is adjusted to be lower than or level with the highest point of the ramp 4, thereby making the movement of the workpiece to be maintained convenient and labor-saving, and effectively improving the maintenance efficiency of the workpiece to be maintained.

Specifically, as shown in FIGS. 1-3, fixing plates are mounted on two opposite sides of the base 11 along the first direction, and two ramps 4 are respectively connected to the two fixing plates, so as to symmetrically arrange the two ramps 4 on two opposite sides of the base 11 along the first direction.

In some embodiments, the maintenance frame 3 includes a vertical column 31, an adapter 32, a first fastener 34 and a second fastener 35. The vertical column 31 extends in an up-down direction, with its lower end connected to the workbench 13. The adapter 32 is pivotally connected to the vertical column 31 around a first axis extending in the up-down direction; the clamp 33 is pivotally connected to the adapter 32 around a second axis perpendicular to the first axis. The first fastener 34 is used to fasten the vertical column 31 and the adapter 32, and the second fastener 35 is used to fasten the adapter 32 and the clamp 33.

Thus, the workpiece to be maintained fixed by the clamp 33 can rotate 360° around the vertical axis and also 360° around the horizontal axis, making the position adjustment of the workpiece to be maintained more flexible and further improving the maintenance efficiency of the workpiece to be maintained.

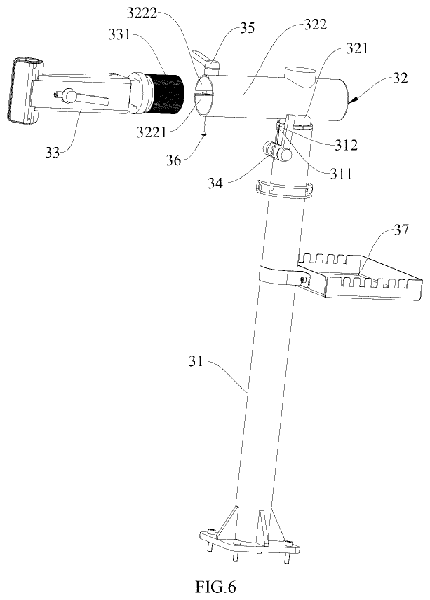

Specifically, as shown in FIGS. 5 and 6, the vertical column 31 is a hollow tubular structure, and its lower end is connected to a support bottom seat, and the support bottom seat is connected to the workbench 13 via a plurality of bolts, and the support bottom seat and the bottom seat 2 are arranged along the second direction. In addition, the adapter 32 is rotatably fitted in the cavity of the vertical column 31 around the central axis of the vertical column 31.

In some embodiments, the maintenance frame 3 further includes a tool box 37 connected to the vertical column 31, and the tool box 37 is formed with an accommodating cavity for storing a maintenance tool.

Therefore, during the maintenance of the workpiece to be maintained, maintenance personnel can quickly access the maintenance tool in the tool box 37, further improving the maintenance efficiency of the workpiece to be maintained.

As shown in FIGS. 5 and 6, the tool box 37 is sleeved on the vertical column 31 through a hoop-like structure.

In some embodiments, the adapter 32 includes a first rod portion 321 extending in the up-down direction. The vertical column 31 includes a first clamping portion 311 and a second clamping portion 312 arranged along the circumferential direction of the vertical column 31. A first end of the first clamping portion 311 is connected to a first end of the second clamping portion 312, and a second end of the first clamping portion 311 is spaced apart from a second end of the second clamping portion 312. The first fastener 34 connects the first clamping portion 311 and the second clamping portion 312 to clamp the first rod portion 321 between the first clamping portion 311 and the second clamping portion 312.

That is, the clamping and fixing of the first rod portion 321 are achieved by reducing the gap between the second end of the first clamping portion 311 and the second end of the second clamping portion 312. Thus, the connection between the adapter 32 and the vertical column 31 is convenient and reliable, and the angle adjustment is easy.

Specifically, as shown in FIG. 6, the first fastener 34 includes a first screw rod and a first toggle lever connected at an angle. A first connecting block and a second connecting block are respectively provided at the outer surfaces of the first clamping portion 311 and the second clamping portion 312. The first connecting block is provided with a first mounting hole, and the first screw rod passes through the first mounting hole and is threadedly fitted with the second connecting block. By toggling the first toggle lever, the width of the gap between the second end of the first clamping portion 311 and the second end of the second clamping portion 312 can be adjusted.

In some embodiments, the adapter 32 further includes a second rod portion 322 extending in the horizontal direction. The second rod portion 322 includes a third clamping portion 3221 and a fourth clamping portion 3222 arranged along the circumferential direction of the second rod portion 322. A first end of the third clamping portion 3221 is connected to a first end of the fourth clamping portion 3222, and a second end of the third clamping portion 3221 is spaced apart from a second end of the fourth clamping portion 3222. The second fastener 35 connects the third clamping portion 3221 and the fourth clamping portion 3222 to clamp a part of the clamp 33 between the third clamping portion 3221 and the fourth clamping portion 3222.

That is, the clamping and fixing of the part of the clamp 33 located in the inner cavity of the second rod portion 322 are achieved by reducing the gap between the second end of the third clamping portion 3221 and the second end of the fourth clamping portion 3222. Thus, the connection between the clamp 33 and the adapter 32 is convenient and reliable, and the angle adjustment of the clamp 33 is easy.

Specifically, as shown in FIG. 6, the second fastener 35 includes a second screw rod and a second toggle lever connected at an angle. A third connecting block and a fourth connecting block are respectively provided at the outer surfaces of the third clamping portion 3221 and the fourth clamping portion 3222. The third connecting block is provided with a second mounting hole, and the second screw rod passes through the second mounting hole and is threadedly fitted with the fourth connecting block. By toggling the second toggle lever, the width of the gap between the second end of the third clamping portion 3221 and the second end of the fourth clamping portion 3222 can be adjusted.

In some embodiments, as shown in FIG. 6, the outer peripheral surface of the part of the clamp 33 located between the third clamping portion 3221 and the fourth clamping portion 3222 is provided with a knurling 331. The knurling 331 effectively increases the friction between the clamp 33 and the third clamping portion 3221 and between the clamp 33 and the fourth clamping portion 3222, further ensuring the connection strength between the clamp 33 and the adapter 32, and preventing the clamp 33 from detaching from the adapter 32 when the direction of the clamp 33 is rotationally adjusted relative to the adapter 32.

In some embodiments, as shown in FIG. 6, a threaded hole is provided at the third clamping portion 3221 or the fourth clamping portion 3222, and the maintenance frame 3 further includes a first threaded member 36 threadedly fitted with the threaded hole to compress the clamp 33, which further improves the connection strength between the clamp 33 and the adapter 32, ensuring higher fixing reliability of the workpiece to be maintained on the workbench 13 during maintenance.

In some embodiments, the bottom seat 2 includes a first limiting member 21, a second limiting member 22 and a clamping member 23. The first limiting member 21 is connected to the workbench 13, and the second limiting member 22 is connected to the workbench 13, and the second limiting member 22 and the first limiting member 21 are arranged along the second direction. The clamping member 23 is movably connected to the second limiting member 22 along the second direction, and the limiting groove is formed between the first limiting member 21 and each of the clamping member 23 and the second limiting member 22.

That is, the distance between the clamping member 23 and the first limiting member 21 is adjustable, thereby ensuring higher limiting reliability of the bottom seat 2 for the workpiece to be maintained arranged in the limiting groove along the second direction.

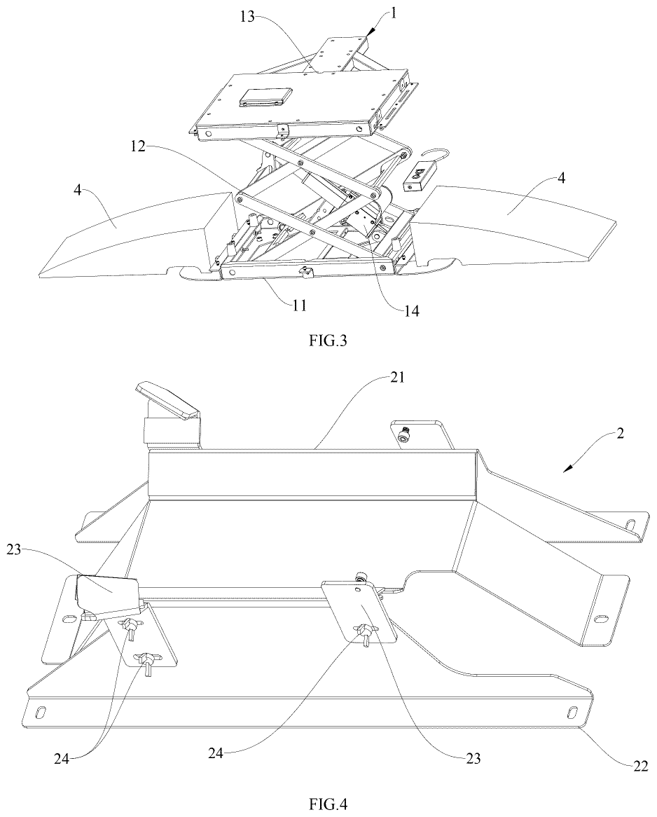

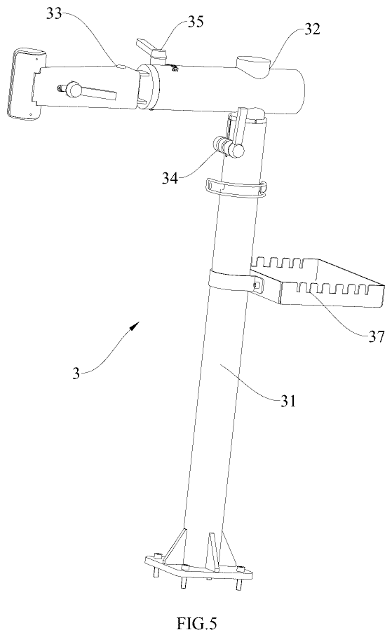

Specifically, as shown in FIGS. 1 and 4, the bottom seat 2 is detachably connected to the workbench 13 via a plurality of bolts. The shape of the limiting groove formed by the bottom seat 2 is substantially matched with the shape of the workpiece to be maintained, and the bottom seat 2 also provides reliable upward support for the workpiece to be maintained.

In some embodiments, the bottom seat 2 further includes a second threaded member 24. The second limiting member 22 is provided with a second threaded hole, and the clamping member 23 is provided with a mounting hole. A screw rod portion of the second threaded member 24 passes through the mounting hole and is threadedly fitted with the second threaded hole, and the clamping member 23 is slidably fitted between a head portion of the second threaded member 24 and the second limiting member 22 along the second direction.

Thus, the movement of the clamping member 23 along the second direction is convenient and fast, and the cost of limiting the workpiece to be maintained by the bottom seat 2 along the second direction is low.

Specifically, the second direction is orthogonal to both the first direction and the up-down direction. As shown in FIG. 4, the clamping member 23 includes two clamping plates arranged at intervals along the first direction. One of the clamping plates is provided with two mounting holes, and the other clamping plate is provided with one mounting hole. Three second threaded members 24 respectively pass through the three mounting holes and are threadedly fitted with the second limiting member 22.

In the description of the present disclosure, it should be understood that the orientation or positional relationship indicated by the terms “center”, “longitudinal”, “transverse”, “up”, “down”, “front”, “rear”, “left”, “right”, “vertical”, “horizontal”, “top”, “bottom”, “inside”, “outside”, “clockwise”, “counterclockwise”, “axial”, “radial” and “periphery” and the like, is bottom seated on the orientation or positional relationship shown in the attached drawings, which is only for the convenience of describing the present disclosure and simplifying the description, and does not indicate or imply that the referred device or element must have a specific orientation, and be constructed and operated in a specific orientation, so it cannot be understood as a limitation of the present disclosure.

In addition, the terms “first” and “second” are only used for purpose of description, and cannot be understood as indicating or implying relative importance or implicitly indicating the number of indicated technical features. Therefore, the feature defined as “first” or “second” may explicitly or implicitly include at least one such feature. In the description of the present disclosure, “a plurality of” means at least two, such as two, three, etc., unless otherwise specifically defined.

In the present disclosure, unless otherwise expressly defined, terms such as “install”, “interconnect”, “connect”, “fix” shall be understood broadly, and may be, for example, fixed connections, detachable connections, or integral connections; may also be mechanical or electrical connections or intercommunication; may also be direct connections or indirect connections via intervening media; may also be inner communications or interactions of two elements, unless otherwise specified. For those skilled in the art, the specific meanings of the above terms in the present disclosure can be understood in specific situations.

In the present disclosure, unless otherwise expressly defined and specified, a structure in which a first feature is “on” or “below” a second feature may include an embodiment in which the first feature is in direct contact with the second feature, or may further include an embodiment in which the first feature and the second feature are in indirect contact through intermediate media. Furthermore, a first feature “on”, “above”, or “on top of” a second feature may include an embodiment in which the first feature is right or obliquely “on”, “above”, or “on top of” the second feature, or just means that the first feature is at a height higher than that of the second feature, while a first feature “below”, “under”, or “on bottom of” a second feature may include an embodiment in which the first feature is right or obliquely “below”, “under”, or “on bottom of” the second feature, or just means that the first feature is at a height lower than that of the second feature.

In the description of the present disclosure, terms such as “an embodiment”, “some embodiments”, “an example”, “a specific example” or “some examples” means that a particular feature, structure, material, or characteristic described in connection with the embodiment or example is included in at least one embodiment or example of the present disclosure. Thus, the appearances of these terms in various places throughout this specification are not necessarily referring to the same embodiment or example of the present disclosure. Furthermore, the particular features, structures, materials, or characteristics may be combined in any suitable manner in one or more embodiments or examples. In addition, without contradiction, those skilled in the art may combine and unite different embodiments or examples or features of the different embodiments or examples described in this specification.

Although embodiments of the present disclosure have been shown and described above, it can be understood that the above embodiments are illustrative and shall not be understood as limitation to the present disclosure, and changes, modifications, alternatives and variations can be made in the above embodiments within the scope of the present disclosure by those skilled in the art.

1. A maintenance lifting platform, comprising:
a lifting main body comprising a height-adjustable workbench;
a bottom seat connected to the workbench and having a limiting groove configured to limit a workpiece to be maintained; and
a maintenance frame connected to the workbench and comprising a clamp configured to clamp the workpiece to be maintained, wherein the clamp is arranged above the bottom seat.

2. The maintenance lifting platform according to claim 1, wherein the lifting main body comprises:
a base;
a scissor support bracket arranged between the base and the workbench;
a driving device mounted on the base and drivingly connected to the scissor support bracket to facilitate lifting and lowering of the workbench; and
a bellows cover, wherein two ends of the bellows cover are respectively connected to the base and the workbench, and the scissor support bracket is located inside the bellows cover.

3. The maintenance lifting platform according to claim 2, wherein the maintenance lifting platform further comprises a ramp connected to the base, and the ramp and the base are arranged along a first direction; and
wherein a height of an upper surface of the ramp gradually decreases in a direction running away from the base; and a height of an upper surface of the workbench at a lowest position is less than or equal to a maximum height of the upper surface of the ramp.

4. The maintenance lifting platform according to claim 1, wherein the maintenance frame comprises:
a vertical column extending in an up-down direction, wherein a lower end of the vertical column is connected to the workbench;
an adapter connected to the vertical column pivotally around a first axis, wherein the first axis extends in the up-down direction, the clamp is connected to the adapter pivotally around a second axis, and the second axis is perpendicular to the first axis;
a first fastener configured to fasten the vertical column and the adapter; and
a second fastener configured to fasten the adapter and the clamp.

5. The maintenance lifting platform according to claim 4, wherein the maintenance frame further comprises a tool box connected to the vertical column and formed with an accommodating cavity configured for a maintenance tool.

6. The maintenance lifting platform according to claim 4, wherein the adapter comprises a first rod portion extending in the up-down direction; and the vertical column comprises a first clamping portion and a second clamping portion arranged along a circumferential direction of the vertical column; and
wherein a first end of the first clamping portion is connected to a first end of the second clamping portion; a second end of the first clamping portion is spaced apart from a second end of the second clamping portion; and the first fastener connects the first clamping portion and the second clamping portion to clamp the first rod portion between the first clamping portion and the second clamping portion.

7. The maintenance lifting platform according to claim 6, wherein the adapter further comprises a second rod portion extending in a horizontal direction; the second rod portion comprises a third clamping portion and a fourth clamping portion arranged along a circumferential direction of the second rod portion; and
wherein a first end of the third clamping portion is connected to a first end of the fourth clamping portion; a second end of the third clamping portion is spaced apart from a second end of the fourth clamping portion; and the second fastener connects the third clamping portion and the fourth clamping portion to clamp a part of the clamp between the third clamping portion and the fourth clamping portion.

8. The maintenance lifting platform according to claim 7, wherein an outer peripheral surface of the part of the clamp located between the third clamping portion and the fourth clamping portion is provided with a knurling; and
a threaded hole is provided in the third clamping portion or the fourth clamping portion; the maintenance frame further comprises a first threaded member threadedly fitted with the threaded hole to compress the clamp.

9. The maintenance lifting platform according to claim 7, wherein an outer peripheral surface of the part of the clamp located between the third clamping portion and the fourth clamping portion is provided with a knurling.

10. The maintenance lifting platform according to claim 7, wherein a threaded hole is provided in the third clamping portion or the fourth clamping portion; the maintenance frame further comprises a first threaded member threadedly fitted with the threaded hole to compress the clamp.

11. The maintenance lifting platform according to claim 1, wherein the bottom seat comprises:
a first limiting member connected to the workbench;
a second limiting member connected to the workbench, wherein the second limiting member and the first limiting member are arranged along a second direction; and
a clamping member connected to the second limiting member movably along the second direction, wherein the limiting groove is formed between the first limiting member and each of the clamping member and the second limiting member.

12. The maintenance lifting platform according to claim 11, wherein the bottom seat further comprises a second threaded member; the second limiting member is provided with a second threaded hole, and the clamping member is provided with a mounting hole; and
wherein a screw rod portion of the second threaded member passes through the mounting hole and is threadedly fitted with the second threaded hole; and the clamping member is fitted between a head portion of the second threaded member and the second limiting member slidably along the second direction.
